(19) United States
(12) Patent Application Publication
(10) Pub. No.: US 2011/0308467 A1
(43) Pub. Date: Dec. 22, 2011

(54) System and Method for Controlling the Speed of a Rotary Milking Platform Using a Rotary Encoder

(76) Inventor: Shawn R. Eckhardt, Sun Prairie, WI (US)

(21) Appl. No.: 12/818,623

(22) Filed: Jun. 18, 2010

(51) Int. Cl. A01J 5/007

(52) U.S. Cl. 119/14.04

(57) ABSTRACT

In certain embodiments, a system includes a rotary encoder, a controller, and a rotary milking platform drive mechanism. The rotary encoder is operable to generate an input signal corresponding to the rotational speed of a rotary encoder wheel contacting at least a portion of a rotary milking platform. The controller is operable to receive the input signal generated by the rotary encoder and determine an actual rotational speed of the rotary milking platform based on the input signal. The controller is further operable to generate an output signal corresponding to a difference in rotational speed between the actual rotational speed of the rotary milking platform and a desired rotational speed for the rotary milking platform. The rotary milking platform drive mechanism is operable to receive the output signal and adjust the actual rotational speed of the rotary milking platform based on the output signal.

### TECHNICAL FIELD

This invention relates generally to dairy farming and more particularly to a system and method for controlling the speed of a rotary milking platform using a rotary encoder.

### BACKGROUND OF THE INVENTION

Over time, the size and complexity of dairy milking operations has increased. Accordingly, the need for efficient and scalable systems and methods that support dairy milking operations has also increased. Systems and methods supporting dairy milking operations, however, have proven inadequate in various respects.

### SUMMARY OF THE INVENTION

According to embodiments of the present disclosure, disadvantages and problems associated with previous systems supporting dairy milking operations may be reduced or eliminated.

In certain embodiments, a system includes a rotary encoder, a controller, and a rotary milking platform drive mechanism. The rotary encoder is operable to generate an input signal corresponding to the rotational speed of a rotary encoder wheel contacting at least a portion of a rotary milking platform. The controller is operable to receive the input signal generated by the rotary encoder and determine an actual rotational speed of the rotary milking platform based on the input signal. The controller is further operable to generate an output signal corresponding to a difference in rotational speed between the actual rotational speed of the rotary milking platform and a desired rotational speed for the rotary milking platform. The rotary milking platform drive mechanism is operable to receive the output signal and adjust the actual rotational speed of the rotary milking platform based on the output signal.

In certain other embodiments, a method for controlling the speed of a rotary milking platform includes receiving an input signal generated by a rotary encoder. The input signal corresponds to the rotational speed of a rotary encoder wheel contacting at least a portion of the rotary milking platform. The method further includes determining, based on the received input signal, an actual rotational speed of the rotary milking platform, generating an output signal corresponding to a difference in speed between the actual rotational speed of the rotary milking platform and a desired rotational speed for the rotary milking platform, and communicating the output signal to a rotary milking platform drive mechanism. The rotary milking platform drive mechanism is operable to adjust the actual rotational speed of the rotary milking platform based on the output signal.

Particular embodiments of the present disclosure may provide one or more technical advantages. For example, the controller, in combination with the rotary encoder and the rotary milking platform drive mechanism, may provide a feedback loop by which the rotational speed of the rotary milking platform may be maintained at or near a desired rotational speed specified by a user. The desired rotational speed may be a speed slow enough to permit dairy cows to safely enter a stall of the rotary milking platform yet fast enough to minimize non-milking time spent in a stall. Accordingly, maintaining the actual rotational speed of the rotary milking platform at or near the desired rotational speed may maximize the number of dairy cows that may be safely milked by the rotary milking platform during a given period of time, thereby increasing the efficiency of the rotary milking platform.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIGS. 1A-1C illustrate top and perspective views of an example rotary milking platform system, according to certain embodiments of the present disclosure; and

FIG. 2 illustrates an example method for controlling the speed of a rotary milking platform, according to certain embodiments of the present disclosure.

### DETAILED DESCRIPTION OF THE DRAWINGS

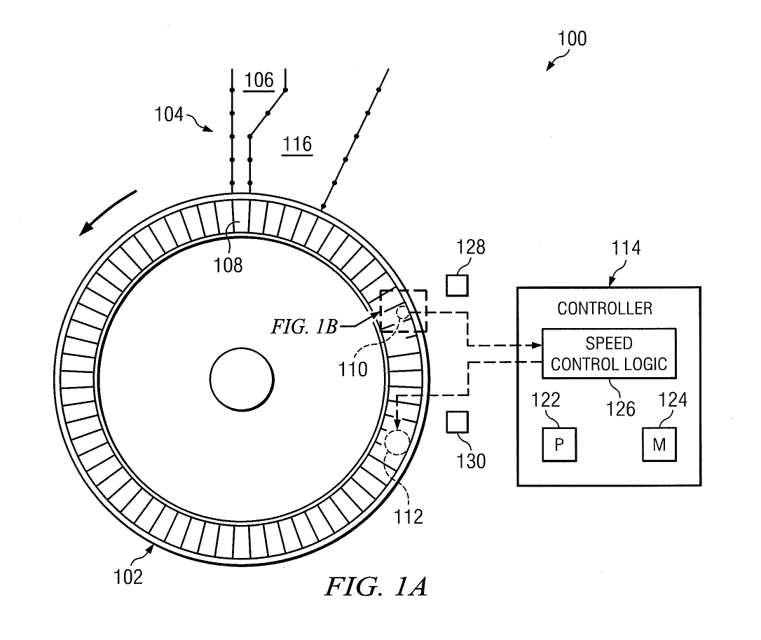

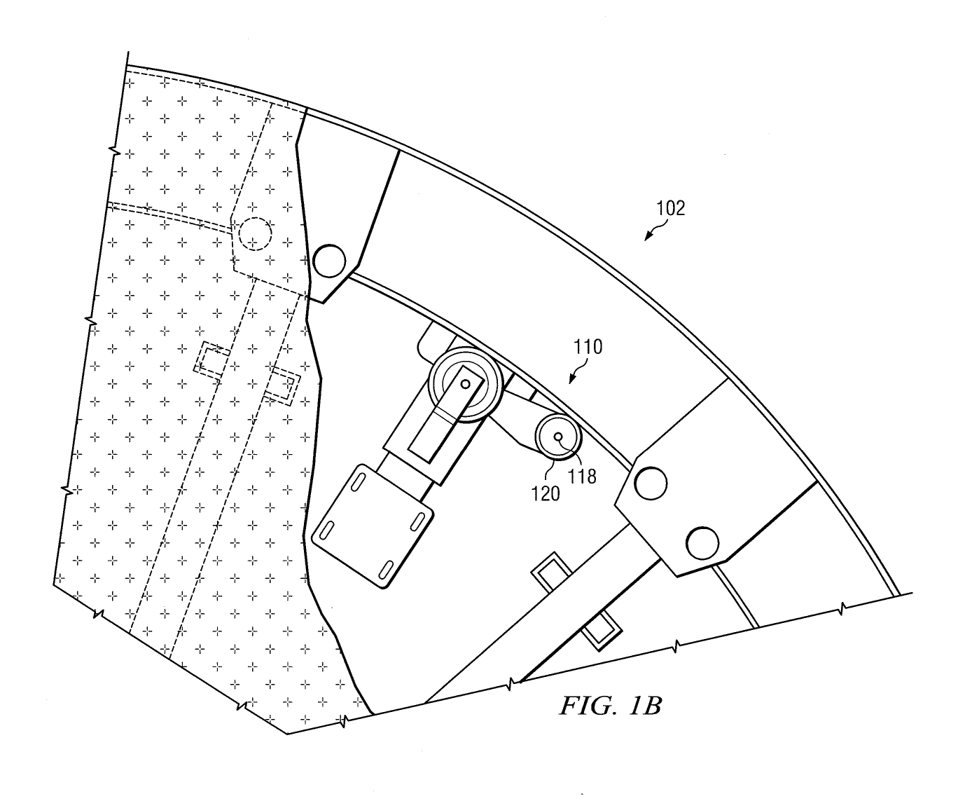

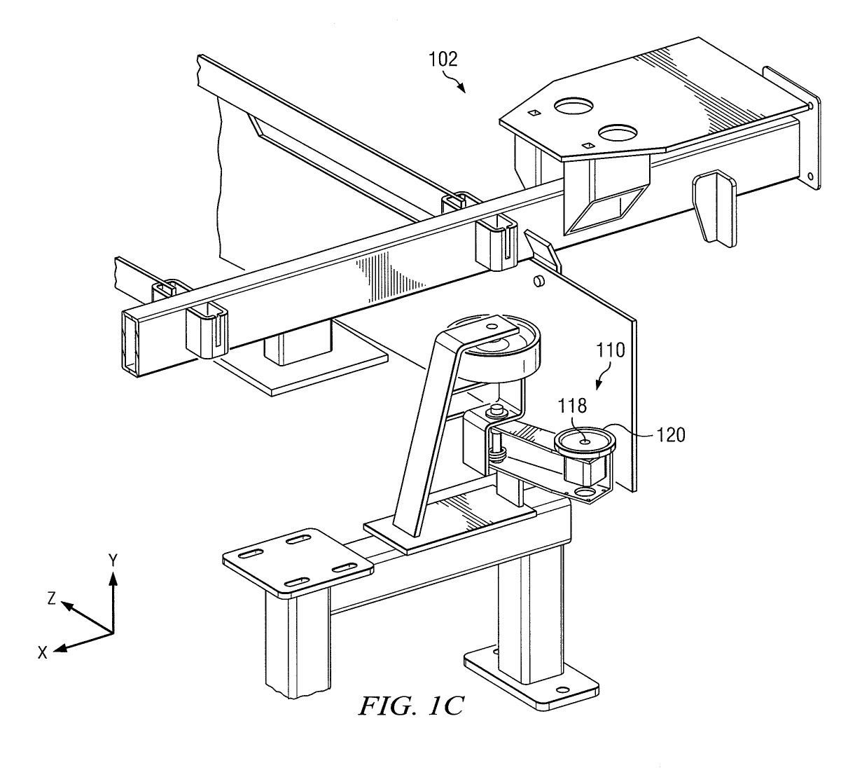

FIGS. 1A-1C illustrate views of an example rotary milking platform system 100, according to certain embodiments of the present disclosure. System 100 includes a rotary milking platform 102 positioned adjacent to an entrance lane 104 such that dairy cows may move from a holding pen 106 into stalls 108 of rotary milking platform 102. System 100 may additionally include a rotary encoder 110 and a rotary drive mechanism 112 each configured to communicate with a controller 114. The rotary encoder 110, rotary drive mechanism 112, and controller 114 may collectively form a feedback loop by which the rotational speed of rotary milking platform 102 may be maintained at or near a desired rotational speed.

In general, a group of dairy cows are held in holding pen 106 prior to being milked in the one or more stalls 108 of rotary milking platform 102. By decreasing the effective area of holding pen 106 (e.g., using a crowd gate), the dairy cows are encouraged to pass one at a time though entrance lane 104 and into stalls 108 of rotary milking platform 102. The dairy cows are then milked as the stalls 108 of rotary milking platform 102 rotate, with the dairy cows being discharged into an exit pen 116 after rotary milking platform 102 completes a single rotation. The rotational speed of rotary milking platform 102 may be an important variable in the overall efficiency of rotary milking platform system 100. For example, if rotational speed of the rotary milking platform 102 is maintained at or near a desired rotational speed (e.g., a speed slow enough to permit dairy cows to safely enter a stall 108 of rotary milking platform 102 yet fast enough to minimize non-milking time spent in a stall 108), the number of dairy cows that may be safely milked by the rotary milking platform during a given period of time may be maximized, thereby increasing the efficiency of the rotary milking platform system 100.

Rotary milking platform 102 may include any suitable combination of structure and materials forming a circular platform having a number of stalls 108 positioned around the perimeter of the platform such that the stalls 108 rotate about a center point as dairy cows in stalls 108 are milked. Although a rotary milking platform 102 having a particular size and a particular number of stalls 108 is illustrated, the present disclosure contemplates a rotary milking platform 102 having any suitable size and including any suitable number of stalls 108. As one particular example, rotary milking platform 102 may have a diameter of four hundred sixty-two inches and including forty equally sized stalls 108 positioned around the perimeter of the platform.

Entrance lane 104 may include any suitable number of walls each constructed of any suitable materials arranged in any suitable configuration operable to encourage the orderly movement of dairy cows. For example, the walls of entrance lane 104 may each include any number and combination of posts, rails, tubing, rods, connectors, cables, wires, and/or beams operable to form a substantially planar barricade such as a fence, wall, and/or other appropriate structure suitable to encourage the orderly movement of dairy cows.

Holding pen 106 and exit pen 116 may each include any suitable number of walls each constructed of any suitable materials arranged in any suitable configuration operable to form a perimeter structure to serve as a holding area for dairy cows. For example, the walls of holding pen 106 and exit pen 116 may each include any number and combination of posts, rails, tubing, rods, connectors, cables, wires, and/or beams operable to form a barricade such as a fence, wall, and/or other appropriate structure suitable to form a perimeter structure to serve as a holding area for dairy cows.

Entrance lane 104 may be positioned adjacent to one or more stalls 108 of rotary milking platform 102 and between holding pen 106 and rotary milking platform 102. As a result of this configuration, dairy cows in holding pen 106 may move through entrance lane 104 and into one or more stalls 108 of rotary milking platform 102. Exit pen 116 may be positioned adjacent to rotary milking platform 102 and entrance lane 104 on a side of entrance lane 104 opposite the forward direction of rotation of rotary milking platform 102. As a result of this configuration, dairy cows may exit stalls 108 prior to reaching entrance lane 104, permitting additional dairy cows to enter the same stalls 108.

Rotary encoder 110 may include any suitable electro-mechanical device operable to convert an angular position of a shaft 118 into an electrical signal (referred to herein as input signal 128). In certain embodiments, rotary encoder 110 may be operable to generate an input signal 128 comprising electrical pulses, with a particular number of electrical pulses (e.g., 1200 pulses) being generated per revolution of shaft 118. Because shaft 118 may be coupled to a rotary encoder wheel 120, the number of pulses of input signal 128 (in embodiments in which input signal 128 comprises a number of pulsed generated during a predefined amount of time) or the frequency of pulses of input signal 128 (in embodiments in which input signal 128 comprises a continuous stream of pulses) may correspond to the rotational speed of rotary encoder wheel 120.

Rotary encoder 110 may be positioned relative to rotary milking platform 102 such that rotary encoder wheel 120 contacts at least a portion of rotary milking platform 102. Rotary encoder wheel 120 may contact any suitable circular portion of rotary milking platform 102 such that rotation of rotary milking platform 102 causes rotation of rotary encoder wheel 120. For example (as illustrated in FIGS. 1A-1C), rotary encoder wheel 120 may contact an inner portion of a circular band located beneath the floor of stalls 108 near the outer edge of rotary milking platform 102. Because both the circumference of rotary encoder wheel 120 and the circumference of the portion of rotary milking platform 102 which rotary encoder wheel 120 contacts may be known, the rotational speed of rotary encoder wheel 120 may be used to determine an actual rotational speed of rotary milking platform 102 (as discussed in detail below with regard to speed control logic 126).

Rotary drive mechanism 112 may include any suitable device operable to impart variable amounts of rotational force on rotary milking platform 102. In certain embodiments, rotary drive mechanism 112 may include a motor (a hydraulic motor, an electric motor, or any other suitable motor) operable to impart a variable amount of rotational force on rotary milking platform 102 via one or more gears (or any other suitable power transmission mechanism). As just one example, rotary drive mechanism 112 may include a hydraulic motor, a hydraulic pump coupled to the hydraulic motor, and a hydraulic valve positioned between the hydraulic motor and the hydraulic pump. By manipulating the hydraulic valve, the amount of hydraulic fluid reaching the hydraulic motor may be manipulated, thereby changing the speed of the hydraulic motor (and, as a result, the speed of rotation of rotary milking platform 102). Rotary drive mechanism 112 may additionally include an actuator coupled to the hydraulic valve, the actuator operable to manipulate the hydraulic valve in response to the receipt of an output signal 130 from controller 114 (as described in further detail below).

Controller 114 may include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input devices and output devices may include fixed or removable storage media such as a magnetic computer disk, CD-ROM, or other suitable media to both receive input from and provide output to a user. Each computer system may include a personal computer, workstation, network computer, kiosk, wireless data port, personal data assistant (PDA), one or more processors within these or other devices, or any other suitable processing device. In short, controller 114 may include any suitable combination of software, firmware, and hardware. Controller 114 may additionally include one or more processing modules 122 and one or more memory modules 124. Processing modules 122 may each include one or more microprocessors, controllers, or any other suitable computing devices or resources and may work, either alone or with other components of system 100, to provide a portion or all of the functionality of system 100 described herein. Memory modules 124 may take the form of volatile or non-volatile memory including, without limitation, magnetic media, optical media, random access memory (RAM), read-only memory (ROM), removable media, or any other suitable memory component.

Controller 114 may be communicatively coupled (e.g., via a network facilitating wireless or wireline communication) to rotary encoder 110 such that controller 114 may receive input signal 128 from rotary encoder 110, input signal 128 having been generated by rotary encoder 110, as described above. In certain embodiments, input signal 128 may comprise a particular number of pulses generated by rotary encoder 110 over a discrete period of time, the number of pulses corresponding to the amount of rotational movement of shaft 118 during the discrete period of time. In other words, controller 114 may receive discrete input signals 128 at predefined time intervals. In certain other embodiments, input signal 128 may comprise a continuous stream of pulses generated by rotary encoder 110, the frequency of the pulses corresponding to the rate of rotation of shaft 118. In other words, controller 114 may continuously receive an input signal 128.

Controller 114 may include speed control logic 126 (e.g., stored memory module 124). Speed control logic 126 may include any information, logic, and/or instructions stored and/or executed by controller 126 to control the rotational speed of rotary milking platform 102, as described below.

Speed control logic 126 may be operable to determine, based on an input signal 128 received by controller 114 from rotary encoder 110, an actual rotational speed of rotary milking platform 102. In order to determine the actual rotational speed of rotary milking platform 102, speed control logic 126 may first determine, based on the number of pulses of input signal 128 (when input signal 128 comprises a number of pulses generated over a discrete period of time) or the frequency of input pulses of the input signal 128 (when input signal 128 comprises a continuous stream of pulses), a rotational speed of the rotary encoder wheel 120 (as the number of pulses generated by rotary encoder 110 per rotation of the rotary encoder wheel 120 is known). As a particular example, if rotary encoder 110 generates 1200 pulses per revolution and input signal 128 comprises a stream of pulses in which two hundred and fifty pulses are received per second, speed control logic 126 may determine that rotary encoder wheel 120 is rotating at a rate of 12.5 revolutions per minute (because [(250 pulses/second)×(60 seconds/minute)]/[1200 pulses/revolution]=12.5 revolutions/minute).

Speed control logic 126 may then determine the actual rotational speed of rotary milking platform 102 based on the determined rotational speed of the rotary encoder wheel 120. For example, speed control logic 126 may determine the actual rotational speed of rotary milking platform 102 by multiplying the determined rotational speed of rotary encoder wheel 120 by an adjustment factor corresponding to the ratio of the circumference of the rotary encoder wheel 120 to the circumference of the portion of the rotary milking platform 102 with which rotary encoder wheel 120 is in contact. As a simplified example, if the portion of the rotary milking platform 102 with which rotary encoder wheel 120 is in contact has a circumference of 1200 inches and the rotary encoder wheel 120 has a circumference of twelve inches, multiplying the determined rotational speed of rotary encoder wheel 120 (e.g., 12.5 revolutions per minute in the above described example) by a factor of 0.01 (i.e. (12 inches)/(1200 inches) yields the actual rotational speed of the rotary milking platform 102 (0.123 RPM in this example). The determined actual rotational speed of rotary milking platform 102 may be further converted to any suitable units (e.g., an amount of time each stall 108 takes to pass a particular point, such as entrance lane 104, referred to throughout the remainder of this description as “seconds per stall”) based on the dimensions of rotary milking platform 102.

Although speed control logic 126 has been described above as performing a particular series of steps to determine an actual rotational speed of rotary milking platform 102 based on input signal 128 (i.e., by applying the particular formulas described above), the present disclosure contemplates speed control logic 126 performing any suitable series of steps to determine an actual rotational speed of rotary milking platform 102 based on input signal 128. As one alternative example, rather than determining the actual rotational speed of rotary milking platform 102 as described above, speed control logic 126 may instead access a table (e.g., stored in memory module 124) defining a number of pre-calculated actual rotational speeds corresponding to each of a number of pulses (when input signal 128 comprises a number of pulses generated over a discrete period of time) or frequencies of pulses (when input signal 128 comprises a continuous stream of pulses). Based on the number of pulses of the received input signal 128 or the frequency of pulses of the received input signal 128, speed control logic 126 may determine, based on the accessed table, the actual rotational speed of rotary milking platform 102.

Speed control logic 126 may be further operable to determine a difference between the actual rotational speed of rotary milking platform 102 and a desired rotational speed for rotary milking platform 102. The desired rotational speed may be specified by a user and may be accessed from memory module 124 or any suitable location within system 100. For example, a user may specify a desired rotational speed in terms of seconds per stall. Having determined the actual rotational speed of rotary milking platform 102 and converting the actual rotational speed to units of seconds per stall (as described above), speed control logic 126 performs simple subtraction to determine a difference between the determined actual rotational speed of rotary milking platform 102 and the user-specified desired rotational speed for rotary milking platform 102.

Speed control logic 126 may be further operable to generate an output signal 130 corresponding to the determined difference in speed between the actual rotational speed of rotary milking platform 102 and a desired rotational speed for rotary milking platform 102. Output signal 130 may be any suitable signal operable to cause rotary drive mechanism 112 to adjust the speed of rotary milking platform 102 an amount corresponding to the determined difference in speed determined by speed control logic 126 (as described in further detail below).

Controller 114 may be communicatively coupled (e.g., via a network facilitating wireless or wireline communication) to rotary drive mechanism 112 such that output signal 130 generated by speed control logic 126 may be communicated to rotary drive mechanism 112. Rotary drive mechanism 112 may be operable to receive output signal 130 and adjust the rotational speed of rotary milking platform 102 based on output signal 130. For example, in embodiments in which rotary drive mechanism 112 includes a hydraulic motor, a hydraulic pump coupled to the hydraulic motor, a hydraulic valve positioned between the hydraulic motor and the hydraulic pump, and an actuator coupled to the hydraulic valve, the actuator my be operable to receive output signal 130 and manipulate the hydraulic valve an amount corresponding to the difference in speed indicated by the received output signal 130. As a result, the speed of rotary milking platform may be adjusted in response to output signal 130. In certain embodiments, the actuator may be operable to determine a rate at which to manipulate the valve according to proportional integral derivative (PID) principles, thereby changing the speed of the hydraulic motor (as well as rotary milking platform 102) gradually.

The above-described functionality associated with rotary encoder 110, controller 114 (including speed control logic 126), and rotary drive mechanism 112 may collectively provide a feedback loop by which the speed of rotary milking platform 102 may be maintained at or near a desired speed specified by a user. Because the desired speed may be a speed determined by the user to produce optimal efficiency (e.g., a speed slow enough to permit dairy cows to safely enter a stall 108 of rotary milking platform 102 yet fast enough to minimize non-milking time spent in a stall 108), system 100 may increase the efficiency of the rotary milking platform, thereby increasing overall milk production.

Although a particular implementation of system 100 is illustrated and primarily described, the present disclosure contemplates any suitable implementation of system 100, according to particular needs. Moreover, although system 100 is primarily described as facilitating the milking of dairy cows, the present disclosure contemplates system 100 facilitating the milking of any suitable dairy livestock (e.g., cows, goats, etc.).

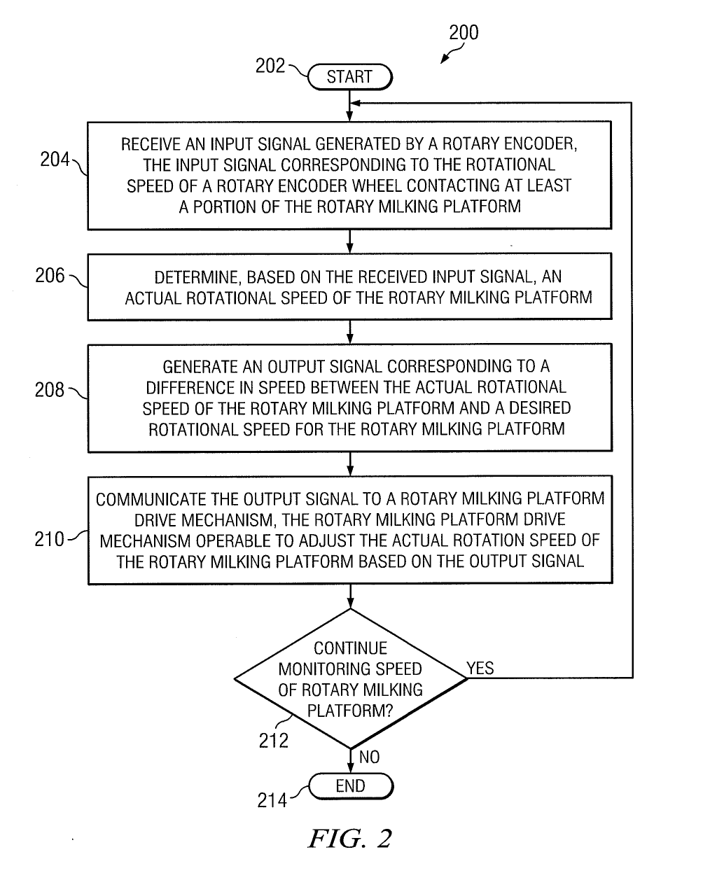

FIG. 2 illustrates an example method 200 for controlling the speed of rotary milking platform 102, according to certain embodiments of the present disclosure. The method begins at step 202. At step 204, controller 114 receives an input signal 128 generated by rotary encoder 110. In certain embodiments, input signal 128 may include a number of pulses generated by rotary encoder 110 during a predefined period of time. In certain other embodiments, input signal 128 may include a continuous stream of pulses generated by rotary encoder 110. Because rotary encoder 110 may generate a specified number of pulses per revolution of rotary encoder wheel 120, the number of pulses of input signal 128 (in embodiments in which input signal 128 includes a number of pulses generated by rotary encoder 110 during a predefined period of time) or the frequency of pulses of input signal 128 (in embodiments in which input signal 128 includes a continuous stream of pulses generated by rotary encoder 110) corresponds to the rotational speed of a rotary encoder wheel 120 contacting at least a portion of rotary milking platform 102.

At step 206, speed control logic 126 of controller 114 determines an actual rotational speed of rotary milking platform 102 based on the received input signal 128. Speed control logic 126 may determine the actual rotational speed of rotary milking platform 102 by determining the rotational speed of rotary encoder wheel 120 (based on the number or frequency of pulses of signal 128) and multiplying the rotational speed of rotary encoder wheel 120 by an adjustment factor corresponding to the ratio of the circumference of the rotary encoder wheel 120 to the circumference of the portion of the rotary milking platform 102 with which rotary encoder wheel 120 is in contact. Having determined the actual rotational speed of the rotary milking platform 102 (e.g., in units of revolutions per minute), speed control logic 126 may be further operable to convert the determined actual rotational speed of rotary milking platform 102 to any suitable units (e.g., seconds per stall) based on the dimensions of rotary milking platform 102.

At step 208, speed control logic 126 of controller 114 generates an output signal 130 corresponding to a difference in speed between the actual rotational speed of rotary milking platform 102 and a desired rotational speed for the rotary milking platform 102. The desired rotational speed of the rotary milking platform 102, which may be specified by user input, may be accessed by speed control logic 126 from memory module 124 or any other suitable location within system 100.

At step 210, the determined output signal 130 is communicated to rotary milking platform drive mechanism 112. Rotary milking platform drive mechanism 112 may be operable to adjust the actual rotational speed of the rotary milking platform 102 based on the output signal 130. For example, in embodiments in which rotary drive mechanism 112 includes a hydraulic motor, a hydraulic pump coupled to the hydraulic motor, a hydraulic valve positioned between the hydraulic motor and the hydraulic pump, and an actuator coupled to the hydraulic valve, the actuator my be operable to receive output signal 130 and manipulate the hydraulic valve an amount corresponding to the difference in speed indicated by the received output signal 130. As a result, the amount of hydraulic fluid reaching the hydraulic motor may be manipulated, thereby changing the speed of the hydraulic motor as well as the speed of rotary milking platform 102. In certain embodiments, the actuator may be operable to determine a rate at which to manipulate the valve according to PID principles, thereby changing the speed of the hydraulic motor (as well as rotary milking platform 102) gradually.

At step 212, speed control logic 126 of controller 114 makes a determination regarding whether to continue monitoring the speed of rotary milking platform 102. In certain embodiments, speed control logic 126 may determine that the speed of rotary milking platform 102 should continue to be monitored unless determination a user input specifying otherwise (e.g., a user input shutting down system 100) has been received. In other words, speed control logic 126 may continue monitoring the speed of rotary milking platform 102 so long as system 100 is operational.

If speed control logic 126 determines at step 212 that the speed of rotary milking platform 102 should continue to be monitored, the method returns to step 204. In embodiments in which input signal 128 includes a number of pulses generated over a discrete period of time, a next discrete input signal 128 is received and the method continues as described above. In embodiments in which input signal 128 comprises a continuous stream of pulses, another discrete input signal 128 may not be received (as input signal 128 is continuous); rather, speed control logic may wait a predefined amount of time prior to calculating a next actual rotational speed of rotary milking platform 102 at step 206 and proceeding as described above. Because speed control logic 126 may continue monitoring the speed of rotary milking platform 102 so long as system 100 is operational according to the above-described method, the speed of rotary milking platform 102 may be maintained at or near a desired speed specified by a user. Additionally, because the desired speed may be a speed determined by the user to produce optimal efficiency (e.g., a speed slow enough to permit dairy cows to safely enter a stall 108 of rotary milking platform 102 yet fast enough to minimize non-milking time spent in a stall 108), system 100 may increase the efficiency of the rotary milking platform, thereby increasing overall milk production.

If speed control logic 126 determines at step 212 that the speed of rotary milking platform 102 should not continue to be monitored (e.g., in response to a user input shutting down system 100) the method ends at step 214.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for controlling the speed of a rotary milking platform, comprising:
receiving an input signal generated by a rotary encoder, the input signal corresponding to the rotational speed of a rotary encoder wheel contacting at least a portion of the rotary milking platform;
determining, based on the received input signal, an actual rotational speed of the rotary milking platform;
generating an output signal corresponding to a difference in speed between the actual rotational speed of the rotary milking platform and a desired rotational speed for the rotary milking platform;
communicating the output signal to a rotary milking platform drive mechanism, the rotary milking platform drive mechanism operable to adjust the actual rotational speed of the rotary milking platform based on the output signal.

2. The method of claim 1, wherein:
the rotary encoder is operable to generate a specified number of pulses per revolution of the rotary encoder wheel; and
the input signal comprises a stream of pulses generated by the rotary encoder.

3. The method of claim 2, wherein determining the actual rotational speed of the rotary milking platform comprises:
determining the rotational speed of the rotary encoder wheel based on the frequency of the stream of pulses of the input signal;
applying an adjustment factor to the determined rotational speed of the rotary encoder wheel, the adjustment factor corresponding to a ratio of a circumference of the rotary encoder wheel to a circumference of the portion of the rotary milking platform that the rotary encoder wheel is contacting.

4. The method of claim 3, wherein:
the determined actual rotational speed of the rotary milking platform comprises an actual amount of time each stall of the rotary milking platform takes to pass an entrance lane positioned adjacent to the rotary milking platform; and
the desired rotational speed for the rotary milking platform comprises a desired amount of time each stall of the rotary milking platform should take to pass the entrance lane positioned adjacent to the rotary milking platform.

5. The method of claim 1, wherein the rotary milking platform drive mechanism comprises:
a hydraulic motor coupled to a hydraulic valve, the hydraulic valve regulating the amount of hydraulic fluid reaching the hydraulic motor and thereby regulating the speed of the hydraulic motor; and
an actuator coupled to the hydraulic valve, the actuator operable to manipulate the hydraulic valve.

6. The method of claim 5, wherein the rotary milking platform drive mechanism is operable to adjust the actual rotational speed of the rotary milking platform by receiving, at the actuator, the output signal, the actuator operable to manipulate the hydraulic valve an amount corresponding to the difference in speed between the actual rotational speed of the rotary milking platform and the desired rotational speed for the rotary milking platform.

7. The method of claim 1, wherein the rotary milking platform drive mechanism is operable to adjust the actual rotational speed of the rotary milking platform at a rate determined according to proportional integral derivative (PID) principles.

8. The method of claim 1, wherein:
the rotary milking platform drive mechanism comprises:
an alternating current (AC) electric drive motor; and
a variable frequency drive operable to adjust the speed of the AC electric drive motor by changing the frequency of current applied to the AC electric drive motor; and
the rotary milking platform drive mechanism is operable to adjust the actual rotational speed of the rotary milking platform by receiving, at the variable frequency drive, the output signal, the variable frequency drive operable to adjust the frequency of current applied to the AC electric drive motor an amount corresponding to the difference in speed between the actual rotational speed of the rotary milking platform and the desired rotational speed for the rotary milking platform.

9. The method of claim 1, wherein
the rotary milking platform drive mechanism comprises:
a direct current (DC) electric drive motor; and
a variable frequency drive operable to adjust the speed of the DC electric drive motor by changing the voltage applied to the DC electric drive motor; and
the rotary milking platform drive mechanism is operable to adjust the actual rotational speed of the rotary milking platform by receiving, at the variable frequency drive, the output signal, the variable frequency drive operable to adjust the voltage applied to the DC electric drive motor an amount corresponding to the difference in speed between the actual rotational speed of the rotary milking platform and the desired rotational speed for the rotary milking platform.

10. The method of claim 1, wherein desired rotational speed for the rotary milking platform is specified by user input.

11. A system, comprising:
a rotary encoder operable to generate an input signal corresponding to the rotational speed of a rotary encoder wheel contacting at least a portion of a rotary milking platform;
a controller operable to:
receive the input signal generated by the rotary encoder;
determine, based on the received input signal, an actual rotational speed of the rotary milking platform; and
generate an output signal corresponding to a difference in rotational speed between the actual rotational speed of the rotary milking platform and a desired rotational speed for the rotary milking platform; and
a rotary milking platform drive mechanism operable to:
receive the output signal; and
adjust the actual rotational speed of the rotary milking platform based on the output signal.

12. The system of claim 11, wherein:
the rotary encoder is operable to generate a specified number of pulses per revolution of the rotary encoder wheel; and
the input signal comprises a stream of pulses generated by the rotary encoder.

13. The system of claim 12, wherein the controller is operable to determine the actual rotational speed of the rotary milking platform by:
determining the rotational speed of the rotary encoder wheel based on the frequency of the stream of pulses of the input signal;
applying an adjustment factor to the determined rotational speed of the rotary encoder wheel, the adjustment factor corresponding to a ratio of a circumference of the rotary encoder wheel to a circumference of the portion of the rotary milking platform that the rotary encoder wheel is contacting.

14. The system of claim 13, wherein:
the determined actual rotational speed of the rotary milking platform comprises an actual amount of time each stall of the rotary milking platform takes to pass an entrance lane positioned adjacent to the rotary milking platform; and
the desired rotational speed for the rotary milking platform comprises a desired amount of time each stall of the rotary milking platform should take to pass the entrance lane positioned adjacent to the rotary milking platform.

15. The system of claim 11, wherein the rotary milking platform drive mechanism comprises:
a hydraulic motor coupled to a hydraulic valve, the hydraulic valve regulating the amount of hydraulic fluid reaching the hydraulic motor and thereby regulating the speed of the hydraulic motor; and
an actuator coupled to the hydraulic valve, the actuator operable to manipulate the hydraulic valve.

16. The system of claim 15, wherein the rotary milking platform drive mechanism is operable to adjust the actual rotational speed of the rotary milking platform by receiving, at the actuator, the output signal, the actuator operable to manipulate the hydraulic valve an amount corresponding to the difference in speed between the actual rotational speed of the rotary milking platform and the desired rotational speed for the rotary milking platform.

17. The system of claim 11, wherein the rotary milking platform drive mechanism is operable to adjust the actual rotational speed of the rotary milking platform at a rate determined according to proportional integral derivative (PID) principles.

18. The system of claim 11, wherein:
the rotary milking platform drive mechanism comprises:
an alternating current (AC) electric drive motor; and
a variable frequency drive operable to adjust the speed of the AC electric drive motor by changing the frequency of current applied to the AC electric drive motor; and
the rotary milking platform drive mechanism is operable to adjust the actual rotational speed of the rotary milking platform by receiving, at the variable frequency drive, the output signal, the variable frequency drive operable to adjust the frequency of current applied to the AC electric drive motor an amount corresponding to the difference in speed between the actual rotational speed of the rotary milking platform and the desired rotational speed for the rotary milking platform.

19. The system of claim 11, wherein
the rotary milking platform drive mechanism comprises:
a direct current (DC) electric drive motor; and
a variable frequency drive operable to adjust the speed of the DC electric drive motor by changing the voltage applied to the DC electric drive motor; and
the rotary milking platform drive mechanism is operable to adjust the actual rotational speed of the rotary milking platform by receiving, at the variable frequency drive, the output signal, the variable frequency drive operable to adjust the voltage applied to the DC electric drive motor an amount corresponding to the difference in speed between the actual rotational speed of the rotary milking platform and the desired rotational speed for the rotary milking platform.

20. The system of claim 11, wherein desired rotational speed for the rotary milking platform is specified by user input.

21. A rotary milking platform controller, comprising:
one or more memory modules operable to store an input signal corresponding to the rotational speed of a rotary encoder wheel contacting at least a portion of a rotary milking platform;
one or more processing modules operable to:
determine, based on the input signal, an actual rotational speed of the rotary milking platform; and
generate an output signal corresponding to a difference in rotational speed between the actual rotational speed of the rotary milking platform and a desired rotational speed for the rotary milking platform, wherein a rotary milking platform drive mechanism is operable to adjust the actual rotational speed of the rotary milking platform based on the output signal.

22. The controller of claim 21, wherein:
the rotary encoder is operable to generate a specified number of pulses per revolution of the rotary encoder wheel; and
the input signal comprises a stream of pulses generated by the rotary encoder.

23. The controller of claim 22, wherein the one or more processing modules are operable to determine the actual rotational speed of the rotary milking platform by:
determining the rotational speed of the rotary encoder wheel based on the frequency of the stream of pulses of the input signal;
applying an adjustment factor to the determined rotational speed of the rotary encoder wheel, the adjustment factor corresponding to a ratio of a circumference of the rotary encoder wheel to a circumference of the portion of the rotary milking platform that the rotary encoder wheel is contacting.

24. The controller of claim 23, wherein:
the determined actual rotational speed of the rotary milking platform comprises an actual amount of time each stall of the rotary milking platform takes to pass an entrance lane positioned adjacent to the rotary milking platform; and
the desired rotational speed for the rotary milking platform comprises a desired amount of time each stall of the rotary milking platform should take to pass the entrance lane positioned adjacent to the rotary milking platform.

25. The controller of claim 21, wherein the rotary milking platform drive mechanism comprises:
a hydraulic motor coupled to a hydraulic valve, the hydraulic valve regulating the amount of hydraulic fluid reaching the hydraulic motor and thereby regulating the speed of the hydraulic motor; and
an actuator coupled to the hydraulic valve, the actuator operable to manipulate the hydraulic valve.

26. The controller of claim 25, wherein the rotary milking platform drive mechanism is operable to adjust the actual rotational speed of the rotary milking platform by receiving, at the actuator, the output signal, the actuator operable to manipulate the hydraulic valve an amount corresponding to the difference in speed between the actual rotational speed of the rotary milking platform and the desired rotational speed for the rotary milking platform.

27. The controller of claim 21, wherein the rotary milking platform drive mechanism is operable to adjust the actual rotational speed of the rotary milking platform at a rate determined according to proportional integral derivative (PID) principles.

28. The controller of claim 21, wherein:
the rotary milking platform drive mechanism comprises:
an alternating current (AC) electric drive motor; and
a variable frequency drive operable to adjust the speed of the AC electric drive motor by changing the frequency of current applied to the AC electric drive motor; and
the rotary milking platform drive mechanism is operable to adjust the actual rotational speed of the rotary milking platform by receiving, at the variable frequency drive, the output signal, the variable frequency drive operable to adjust the frequency of current applied to the AC electric drive motor an amount corresponding to the difference in speed between the actual rotational speed of the rotary milking platform and the desired rotational speed for the rotary milking platform.

29. The controller of claim 21, wherein
the rotary milking platform drive mechanism comprises:
a direct current (DC) electric drive motor; and
a variable frequency drive operable to adjust the speed of the DC electric drive motor by changing the voltage applied to the DC electric drive motor; and
the rotary milking platform drive mechanism is operable to adjust the actual rotational speed of the rotary milking platform by receiving, at the variable frequency drive, the output signal, the variable frequency drive operable to adjust the voltage applied to the DC electric drive motor an amount corresponding to the difference in speed between the actual rotational speed of the rotary milking platform and the desired rotational speed for the rotary milking platform.

30. The controller of claim 21, wherein desired rotational speed for the rotary milking platform is specified by user input.
